(19) United States
(12) Patent Application Publication
(10) Pub. No.: US 2007/0190223 A1
(43) Pub. Date: Aug. 16, 2007

(54) SOY/WHEY PROTEIN RECOVERY COMPOSITION

(75) Inventors: PETER L. BORDI JR., University Park, PA (US); GEORGE SALVATERRA, University Park, PA (US); THOMAS PALCHAK, University Park, PA (US); CONSTANCE COLE, University Park, PA (US)

Correspondence Address: MCKEE, VOORHEES & SEASE, P.L.C.;ATTN: PENNSYLVANIA STATE UNIVERSITY, 801 GRAND AVENUE, SUITE 3200, DES MOINES, IA, 50309-2721, US

(73) Assignee: THE PENN STATE RESEARCH FOUNDATION, University Park, PA (US)

(21) Appl. No.: 11/621,715

(22) Filed: Jan. 10, 2007

Related U.S. Application Data
(60) Provisional application No. 60/757,945, filed on Jan. 11, 2006.
(60) Provisional application No. 60/823,418, filed on Aug. 24, 2006.

(51) Int. Cl. A23L 1/20

(52) U.S. Cl. 426/634

(57) ABSTRACT

A novel soy/milk protein composition is disclosed which can be in drink, powder or gel from which acts as a sports recovery drink restores tissue to its pre-exercise or illness state, reduces muscle glycogen breakdown, and acts to forestalls and prevent the catabolic effects of strenuous exercise. The composition includes soy protein, carbohydrate, water, vegetable oil, and an emulsifier in an appropriate ratio to maximize taste and beneficial effects of the same.

### CROSS-REFERENCE TO RELATED APPLICATIONS

This application claims priority under 35 U.S.C. § 119 of provisional applications Ser. No. 60/757,945 filed Dec. 11, 2006 and Ser. No. 60/823,418 filed Aug. 24, 2006, which are hereby incorporated by reference in their entirety.

### FIELD OF THE INVENTION

This invention relates to the preparation of a soy protein drink that replenishes carbohydrate and protein.

### BACKGROUND OF THE INVENTION

Training, exercise, and illness are stressful to the human body. These events result in fluid loss, depletion of glycogen stores, subversion of immune response, and eventual catabolism of muscle. Nutrition as aid to muscle recovery is the key to maximizing the training and/or recovery process. Carbohydrates and proteins are the fuels used during exercise and illness. Eventually the stores are depleted and the result is an energy debt, thereby resulting in the aforementioned muscle catabolism.

Replenishing carbohydrate and protein is necessary for the restoration of tissue to the pre-exercise or illness state. Replacing these nutrients after exercise or illness reduces muscle glycogen breakdown. The conservation of glycogen stores abates fatigue and enhances performance. Immediately after exercise, the enzymes responsible for glycogen storage are more productive. Consuming carbohydrate and protein at this time maximizes the effect. (Ivy, 2001).

In study subjects performing exercise at 85% VO₂ₘₐₓ until exhausted and consuming water, carbohydrate, or carbohydrate-protein supplements the subjects consuming a carbohydrate-protein supplement could perform the tasks longer. The consumption of only carbohydrates during exercise increases stress hormones, limiting stress-related immunosuppression (Gleeson, 2004, 2001). Pre-exercise consumption of a carbohydrate protein supplement increases insulin levels. Insulin counteracts the catabolic effects of cortisol on muscle. (Tipton, 2001). Post-exercise consumption improved subsequent performance (Roy, 2002) and reduced injury and illness (Flakoll, 2003).

There are a variety of products currently available which are alleged to aid in muscle recovery. These products may be broken down into the following categories: protein replacement products, amino acid supplements, and herbal supplements. The protein replacement products are condensed forms of protein that can be problematic because of their high protein content. Specifically, their high amount of protein can actually exacerbate the dehydration process already begun by the exercise itself. This increases the user's need for adequate hydration.

Amino acid supplements are comprised of specific amino acids. Total Recovery™ is an example of such a product, which includes L-glutamine and MSM. While supplementing the formulation with one type of amino acid can be beneficial, it is usually done at the expense of other amino acids. For instance, while glutamine may increase endurance because of its effects on lactic acid levels, the depletion of other amino acids may actually contribute to injury.

Herbal supplements are marketed as aiding in exercise recovery. However, to date the physiological effects of these herbs have not been defined, nor have the manner by which they are metabolized.

It is an object of the present invention to provide a sports recovery drink restores tissue to its pre-exercise or illness state.

It is a further object of the invention to provide a composition which reduces muscle glycogen breakdown.

It is yet a further object to provide a composition which forestalls and prevents the catabolic effects of strenuous exercise.

### SUMMARY OF THE INVENTION

The present invention relates to a soy protein composition that replenishes both carbohydrate and protein that are lost due to exercise, illness, or other stress-related factors. The drink includes soy protein which may partially replaced with milk protein, most preferably up to 50%., which further enhances the benefits of a carbohydrate-protein supplement. The use of soy in the recovery process generates less oxidative tissue damage over time.

The composition also includes a source of carbohydrate, or sugar which can be a flavoring agent, or any other form of glucose. According to the invention, cocoa is the preferred flavoring agent.

The composition also includes oils, emulsifiers and water. The soy/milk protein serves as the protein source, while the cocoa (or other flavoring) provides the necessary source of carbohydrate.

The nutritional composition of the preferred and alternate embodiments of the present invention may be in a dry form, a liquid drink, a bar or a gel format. The nutritional composition is used to enhance performance and extend endurance during exercise and prevent muscle damage.

In the present invention the preferred and alternate embodiments of the nutritional composition are as follows for a dry composition and for a liquid drink composition.

### DETAILED DESCRIPTION OF THE INVENTION

According to the invention, the protein source used in the recovery composition includes soy protein. The positive effects of carbohydrate-protein supplementing are further enhanced with the use of soy as the primary protein source. It is believed that the benefit of the soy to the supplement results in less oxidative tissue damage over time. It is also indicated that soy protein consumed after strenuous exercise reduces the expected catabolic effects of exercise. This effect appears to be increased over time. Soy antioxidant effect is a causative component in blood lipid reduction, thus the heart healthy benefits thereof. Continual consumption of the carbohydrate and soy protein beverage of this invention is beneficial in forestalling and preventing exercise-induced damage and injury. Creatine kinase, myeloperoxidase, and lactic dehydrogenase, all enzymes playing a role in muscle catabolism and oxidative stress increased at a lesser rate in subjects consuming a soy protein when compared with the consumption of a whey protein. These same indicators remain lower in the group consuming soy for more than 10 days after consumption of the protein ceased. Thus the composition of the invention may be used continually in the training process or in the stressed period as well as after for prevention of long term catabolic effects as well as recovery immediately after.

The protein source may be selected from a variety of materials, including without limitation, milk protein, whey protein, caseinate, soy protein, egg whites, gelatins, collagen and combinations thereof, with the primary protein source being soy protein. Included in the protein source may be lactose-free skim milk, milk protein isolate, and whey protein isolate. It is also contemplated to use soy milk with the present compositions. As used herein, soy milk refers to a liquid made by grinding dehulled soy beans, mixing with water, cooking and recovering the dissolved soy milk out of the beans.

Preferably, a soy protein isolate is used as a protein source comprising at least one half of the protein component. The soy protein isolate should contain at least 85% pure protein, with about 88-92% being preferred. Soy protein isolates are well known in the art. Supro XT™ 30 is a preferred soy protein isolate for this purpose. In a preferred embodiment, up to one half of the soy protein may be replaced with whey or other appropriate milk protein. A mixture of 50% soy and 50% milk protein is preferred. The milk protein helps with weight gaining to assure weight stability of the consumer. The protein is present in the composition at a range of from about 1.0-10% by weight.

The carbohydrates or sugar in the present invention can be a mixture of one or more monosaccharides or disaccharides, and preferably in combination with one or more complex carbohydrates. In selecting effective carbohydrates and carbohydrate levels for use in the present compositions, it is important that the carbohydrates and levels thereof which are chosen allow a sufficient rate of digestion and intestinal absorption to provide a steady maintenance of glucose, which in turn provides energy and alertness to the consumer.

Monosaccharides and disaccharides provide immediate energy to the consumer while the complex carbohydrate components, are hydrolyzed in the digestive tract to provide a later, or delayed and maintained, onset of energy for the consumer. The monosaccharide utilized herein is a molecule of the general formula CₙH₂Oₙ, wherein n is an integer equal to or greater than 3. The monosaccharide herein is digestible, i.e., capable of metabolism by a mammalian body. Non-limiting examples of monosaccharides which may be utilized herein include sorbitol, mannitol, erythrose, threose, ribose, arabinose, xylose, xylitol, ribulose, glucose, galactose, mannose, fructose, and sorbose. Preferred monosaccharides for use herein include glucose and fructose, most preferably glucose.

One or more disaccharides may also be used as a source of immediate energy. The disaccharide utilized herein may be a molecule of the general formula CₙH₂ₙ₋₂O_{.n-1}, wherein the disaccharide has 2 monosaccharide units connected via a glycosidic bond. In such formula, n is an integer equal to or greater than 3. The disaccharide herein is “digestible,” i.e., capable of metabolism by the human body. Non-limiting examples of disaccharides which may be utilized herein include sucrose, maltose, lactitol, maltitol, maltulose, and lactose. The most preferred disaccharide for use herein is sucrose. Preferably, sucrose is present in the amount of the range of from about 2.0-10% by weight

The invention may also include a complex carbohydrate such as an oligoosaccharide, polysaccharide, and/or carbohydrate derivative, preferably an oligosaccharide and/or polysaccharide. As used herein, the term “oligosaccharide” means a digestible linear molecule having from 3 to 9 monosaccharide units, wherein the units are covalently connected via glycosidic bonds. As used herein, the term “polysaccharide” means a digestible (i.e., capable of metabolism by the human body) macromolecule having greater than 9 monosaccharide units, wherein the units are covalently connected via glycosidic bonds. The polysaccharides may be linear chains or branched. Preferably, the polysaccharide has from 9 to about 20 monosaccharide units. Carbohydrate derivatives, such as a polyhydric alcohol (e.g., glycerol), may also be utilized as a complex carbohydrate herein. As used herein, the term “digestible” means capable of metabolism by enzymes produced by the human body.

Examples of preferred complex carbohydrates include raffinoses, stachyoses, maltotrioses, maltotetraoses, glycogens, amyloses, amylopectins, polydextroses, and maltodextrins. The most preferred complex carbohydrates are maltodextrins.

Maltodextrins are a form of complex carbohydrate molecule which is several glucose units in length. The maltodextrins are hydrolyzed into glucose in the digestive tract where they provide an extended source of glucose. Maltodextrins may be spray-dried carbohydrate ingredients made by controlled hydrolysis of corn starch. The sugar/carbohydrate portion of the composition is from about 2.0-10% by weight %.

According to the invention, flavoring agents may also be added. The preferred flavoring agent is cocoa. Cocoa adds desirable taste and color to the composition while also contributing a source of complex carbohydrates. Red and Dutch cocoa are preferred for this purpose. Dutch cocoa has had either the whole nibs or the chocolate liquor treated with an alkaline solution, usually potassium carbonate, to raise the pH from 5.5 to 7. This darkens the color, makes the flavor milder, and improves the dispersion of cocoa particles in the liquid. A preservative should also be included to keep the chocolate from breaking down. Sugar is also preferably included to offset the bitterness of the cocoa. The cocoa is preferably de-fatted, by removing substantial amounts of cocoa butter, with the final fat content of the powder ranging from 10 to 35% (most preferred is 22%). The cocoa butter is pressed out of the liquor, and the resulting paste is formed into cakes and then ground. Cocoa is present in the composition from about 2.0-5.0% by weight.

The invention contemplates the inclusion of other flavoring agents including, but not limited to, vanilla, strawberry, and peanut butter. In this regard, vanilla extract (alcohol-free) may be included either alone or to enhance/improve the flavor of the cocoa.

Vegetable oil is also included in the composition to provide good mouth feel and viscosity. Examples of suitable vegetable oils include olive oil, cottonseed oil, linseed oil, soybean oil, safflower oil and corn oil. Canola oil is preferred for this purpose since it has a healthier nutritional profile than most vegetable oils, and has a mild flavor. The vegetable oil is present in about 0.05-5.0% by weight.

Finally, an emulsifier is included. Suitable emulsifiers for use in the invention include, but are not limited to, propane-1,2-diol alginate; konjac; polyoxyl 8 stearate; polyoxyethylene stearate; polysorbate 20; polysorbate 80; ammonium phosphatides; diphosphates; methyl cellulose; hydroxypropyl cellulose; hydroxypropyl methyl cellulose; ethyl methyl cellulose; carboxymethylcellulose; sodium carboxy methyl cellulose; sodium caseinate; magnesium stearate; sodium, potassium, and calcium salts of fatty acids; mono and di glycerides of fatty acids; acetic and fatty acid esters of glycerol; acetic acid esters of mono and di glycerides of fatty acids; lactic and fatty acid esters of glycerol; lactic acid esters of mono and diglycerides of fatty acids; citric and fatty acid esters of glycerol; citric acid esters of mono and diglycerides of fatty acids; sucrose esters of fatty acids; polyglycerol esters of fatty acids; polyglycerol esters of interesterified ricinoleic acid; propylene glycol mono- and di-esters; propane-1,2-diol esters of fatty acids; lactylated fatty acid esters of glycerol and propane-1,2-diol; stearoyl-2-lactylate; calcium stearoyl-2-lactylate; stearyl tartrate; sorbitan monostearate; sorbitan tristearate; sorbitan monolaurate; and sorbitan monopalmitate. A preferred emulsifier is FMC Bio Polymer. The Emulsifier is present from about 0.05-1.0% by weight.

It is understood that other active and inactive ingredients may be added to the soy protein drink and still be encompassed within the scope of this invention, including one or more, flavanols, acidulants, coloring agents, minerals, vitamins, herbs, soluble fibers, non-caloric sweeteners, flavoring agents, preservatives, emulsifiers, oils, carbonation components, and the like. Such optional components may be dispersed, solubilized, or otherwise mixed into the present compositions. These components may be added to the compositions herein provided they do not substantially hinder the properties of the composition. Non-limiting examples of optional components suitable for use herein are given below.

One optional, component of the present invention includes one or more plant phytochemical constituents. This would include flavanols or other phytochemicals which are in essence “healthy.” The inclusion of one or more flavanols serves to delay the glycemic response associated with ingestion of the present compositions, thus providing further maintenance of energy to the user.

Flavanols are natural substances present in a variety of plants (e.g., fruits, vegetables, and flowers). The flavanols which may be utilized in the present invention can be extracted from, for example, fruit, vegetables, or other natural sources by any suitable method well known to those skilled in the art. For example, flavanols may be extracted from either a single plant or mixtures of plants. Many fruits, vegetables, flowers and other plants containing flavanols are known to those skilled in the art. Alternatively, these flavanols may be prepared by synthetic or other appropriate chemical methods and incorporated into the present compositions. Flavanols, including catechin, epicatechin, and their derivatives are commercially available.

The present compositions may optionally comprise one or more acidulants. An amount of an acidulant may be used to maintain the pH of the composition. Compositions of the present invention preferably have a pH of from about 2 to about 8, more preferably from about 2 to about 5, even more preferably from about 2 to about 4.5, and most preferably from about 2.7 to about 4.2. Beverage acidity can be adjusted to and maintained within the requisite range by known and conventional methods, e.g., the use of one or more acidulants. Typically, acidity within the above recited ranges is a balance between maximum acidity for microbial inhibition and optimum acidity for the desired beverage flavor.

Organic as well as inorganic edible acids may be used to adjust the pH of the beverage. The acids can be present in their undissociated form or, alternatively, as their respective salts, for example, potassium or sodium hydrogen phosphate, potassium or sodium dihydrogen phosphate salts. The preferred acids are edible organic acids which include citric acid, phosphoric acid, malic acid, fumaric acid, adipic acid, gluconic acid, tartaric acid, ascorbic acid, acetic acid, phosphoric acid or mixtures thereof. The most preferred acids are citric and phosphoric acids. The acidulant can also serve as an antioxidant to stabilize beverage components. Examples of commonly used antioxidant include but are not limited to ascorbic acid, EDTA (ethylenediaminetetraacetic acid), and salts thereof.

Small amounts of one or more coloring agents may be utilized in the compositions of the present invention. Beta-carotene is preferably used. Riboflavin and FD&C dyes (e.g., yellow #5, blue #2, red #40) and/or FD&C lakes may also be used. By adding the lakes to the other powdered ingredients, all the particles, in particular the colored iron compound, are completely and uniformly colored and a uniformly colored beverage mix is attained. Additionally, a mixture of FD&C dyes or a FD&C lake dye in combination with other conventional food and food colorants may be used. Additionally, other natural coloring agents may be utilized including, for example, chlorophylls and chlorophyllins, as well as fruit, vegetable, and/or plant extracts such as grape, black currant, aronia, carrot, beetroot, red cabbage, and hibiscus. Natural colorants are preferred for “all natural” drink products.

The amount of coloring agent used will vary, depending on the agents used and the color intensity desired in the finished product. The amount can be readily determined by one skilled in the art.

The compositions herein are also optionally fortified with one or more minerals. The U.S. Recommended Daily Intake (USRDI) for minerals are defined and set forth in the Recommended Daily Dietary Allowance-Food and Nutrition Board, National Academy of Sciences-National Research Council.

Minerals which may optionally be included in the compositions herein are, for example, calcium, potassium, magnesium, zinc, iodine, iron, and copper. Any soluble salt of the minerals suitable for inclusion edible compositions can be used, for example, magnesium citrate, magnesium gluconate, magnesium sulfate, zinc chloride, zinc sulfate, potassium iodide, copper sulfate, copper gluconate, and copper citrate.

Calcium is a particularly preferred mineral for use in the present invention. Preferred sources of calcium include, for example, calcium-citrate-lactate, amino acid chelated calcium, calcium carbonate, calcium oxide, calcium hydroxide, calcium sulfate, calcium chloride, calcium phosphate, calcium hydrogen phosphate, calcium dihydrogen phosphate, calcium citrate, calcium malate, calcium titrate, calcium gluconate, calcium realate, calcium tantrate, and calcium lactate, and in particular calcium citrate-malate. The form of calcium citratemalate is described in, e.g., Mehansho et al., U.S. Pat. No. 5,670,344; or Diehl et al., U.S. Pat. No. 5,612,026

Iron may also be utilized in the compositions and methods of the present invention. Acceptable forms of iron are well-known in the art. The amount of iron compound incorporated into the product will vary widely depending upon the level of supplementation desired in the final product and the targeted consumer.

One or more soluble fibers may also optionally be included in the compositions of the present invention to provide, for example, satiation and refreshment, and/or nutritive benefits. Soluble dietary fibers are a form of carbohydrates which cannot be metabolized by the enzyme system produced by the human body and which pass through the small intestine without being hydrolyzed (and, thus, are not included within the definition of complex carbohydrate herein). Without intending to be limited by theory, since soluble dietary fibers swell in the stomach, they slow down gastric emptying thus prolonging the retention of nutrients in the intestine which results in a feeling of satiation.

The compositions herein further may comprise at least three, and preferably more, vitamins provided by a vitamin premix. The U.S. Recommended Daily Intake (USRDI) for vitamins and minerals are defined and set forth in the Recommended Daily Dietary Allowance-Food and Nutrition Board, National Academy of Sciences-National Research Council. Various combinations of these vitamins can be used.

Non-limiting examples of such vitamins, include choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate, vitamin K. Preferably, at least three vitamins are selected from choline bitartate, niacinamide, thiamin, folic acid, d-calcium pantothenate, biotin, vitamin A, vitamin C, vitamin B₁ hydrochloride, vitamin B₂, vitamin B₃, vitamin B₆ hydrochloride, vitamin B₁₂, vitamin D, vitamin E acetate, vitamin K. More preferably, the composition comprises vitamin C and two or more other vitamins selected from choline bitartate, niacinamide, thiamin, folic acid, d-calcium pantothenate, biotin, vitamin A, vitamin B₁ hydrochloride, vitamin B₂, vitamin B₃, vitamin B₆ hydrochloride, vitamin B₁₂, vitamin D, vitamin E acetate, vitamin K. In an especially preferred embodiment of the present invention, a composition comprises vitamin choline bitartate, niacinamide, folic acid, d-calcium panothenate, vitamin A, vitamin B₁ hydrochloride, vitamin B₂, vitamin B₆ hydrochloride, vitamin B₁₂, vitamin C, vitamin E acetate.

Commercially available vitamin A sources may also be included in the present compositions. As used herein, “vitamin A” includes, but is not limited to, vitamin A (retinol), beta-carotene, retinol palmitate, and retinol acetate. Vitamin A sources include other provitamin A carotenoids such as those found in natural extracts that are high in carotenoids with provitamin A activity. Beta-carotene can also serve as a coloring agent as will be discussed later. Commercially available sources of vitamin B₂ (also known as riboflavin) may be utilized in the present compositions. Commercially available sources of vitamin C can be used herein. Encapsulated ascorbic acid and edible salts of ascorbic acid can also be used.

Nutritionally supplemental amounts of other vitamins which may be incorporated herein include, but are not limited to, choline bitartate, niacinamide, thiamin, folic acid, dcalcium pantothenate, biotin, vitamin B₁ hydrochloride, vitamin B₃, vitamin B₆ hydrochloride, vitamin B₁₂, vitamin D, vitamin E acetate, vitamin K.

The present beverage also may be a concentrate in the form of an essentially dry composition. These compositions are typically in, for example, powder, granule, or tablet form. The essentially dry beverage compositions are may be diluted with water or other aqueous fluids, or may be incorporated into other solids such as, for example, bars (e.g., cereal bars, breakfast bars, energy bars, and nutritional bars). The amount of water utilized in the present essentially dry compositions is typically less than about 20%, preferably less than about 10%, more preferably less than about 5%, and most preferably less than about 3%, all by weight of the composition. In these dry compositions, the carbohydrate is present in an amount of between about 30% and about 75% by weight of the composition; the protein is present in an amount of above about 10 and about 50% by weight of the composition.

In a preferred embodiment, the soy/milk protein composition of the present invention includes ingredients in the following concentrations:

| | |
|---|---|
| Soy protein/milk | from about 1.0-10% by weight (about 3.0-5.0% |
| protein isolate | preferred) |
| Sugar | from about 2.0-10% by weight (about 6.0-7.5% |
| | preferred) |
| Vegetable oil | from about 0.05-5.0% by weight (about 0.7-1.0% |
| | preferred) |
| Emulsifier | from about 0.05-1.0% by weight (about 0.2-0.4% |
| | preferred) |
| Water | from about 80-99% by weight (about 83.0-97.0% |
| | preferred) |
| Cocoa | from about 2.0-5.0% by weight (about 3.0-4.0% |
| | preferred) |
| Vanilla extract | from about 0.02-0.5% by weight (about 0.07-0.15% |
| | preferred) |

In general, the soy/milk protein drink of this invention is manufactured by preblending the water and emulsifier to form a slurry, then adding the protein and sugar (if included) with stirring and agitation, then last adding the oil. The mixture is then pasteurized using methods commonly known in the art.

In a preferred method, the dry ingredients are preferably mixed with the water in a commercial blender. The unpasteurized drink is then heat treated at a temperature ranging from about 150-200° F. (with about 179° F. being preferred). This temperature is held for at least 30 seconds, and the mixture is then rapidly cooled to a temperature of 45° F. or lower.

It should be appreciated that minor modifications of the composition and the ranges expressed herein may be made and still come within the scope and spirit of the present invention.

Compositions of the invention may be formulated as follows:

| | | |
|---|---|---|
| Supro xt 30 NIP Non GMA | 45-50 | pounds |
| sugar | 85-100 | pounds |
| Cocoa | 40-50 | pounds |
| Canola Oil | 11.0-12.5 | pounds |
| Stabilizer | 2.8-5 | pounds |
| Vanilla Extract | 10-24 | ounces |
| water | 1150-1223 | pounds |

The most preferred formulation of the present invention is as follows:

| | | |
|---|---|---|
| Soy/milk protein isolate | 47 | pounds |
| Sugar | 90 | pounds |
| Cocoa | 45.5 | pounds |
| Canola oil | 11.4 | pounds |
| Emulsifier | 3.6 | pounds |
| Water | 1203 | pounds |
| Vanilla extract | 15 | ounces |

### EXAMPLE

The composition of the invention was developed to aid the muscle recovery and enhance the subsequent athletic performance of individuals. The chocolate-flavored, soy- and whey-based drink contains more than 6.25 grams of isolated soy protein (ISP) and less than 3 grams of fat in an 8 ounce serving.

In order to assess the effectiveness of the composition in aiding muscle recovery, the inventors recruited 28 physically active male students between the ages of 19 and 23 —all returning members of the Penn State Nittany Lion football team—to participate in a study of the product. 30 members of the football team were contacted by the team's head athletic trainer and asked to participate. Once selected, the subjects were given a verbal and written explanation of the study as well as the risks of procedures and treatment, and informed consent was obtained prior to participation. Two of the 30 participants eventually dropped from the study because of conflicting time commitments.

The study was a seven-week intervention, single blind, randomized, crossover design study. One group of participants consumed the composition of the invention for a three-week period at the beginning and the end of the study, during which time they consumed 20 ounces of the product at two different times each day—once immediately after their workout and the other time before going to bed. The two three-week periods were separated by a 10-day “washout” period during which no sport recovery drink was consumed.

The second group of participants consumed an isolated whey protein (IWP) sport recovery drink that also was created for the study. Both drinks were nutritionally compatible and were produced by the same manufacturer using a similar process for both products. Packaging was identical with the exception of a single blind color coding, and there was no significant difference in the acceptance of the taste of either products.

The composition given the participants was as follows:

| | | |
|---|---|---|
| Soy/milk protein isolate | 47 | pounds |
| Sugar | 90 | pounds |
| Cocoa | 45.5 | pounds |
| Canola oil | 11.4 | pounds |
| Emulsifier | 3.6 | pounds |
| Water | 1203 | pounds |
| Vanilla extract | 15 | ounces |

During the two three-week periods that the participants consumed the sport recovery drinks, all of them also consumed 20 ounces of water each time they consumed 20 ounces of their respective sport recovery drink. Each subject consumed 20 ounces of their respective drink and 20 ounces of water in view of study personnel and signed a log to verify the consumption of the second 20 ounces of protein drink and 20 ounces of water.

Biological markers used during the study to measure tissue damage in plasma were creatine phosphokinase, which is also known as creatine kinase (CK); lactic dehydrogenase (LDH); and myeloperoxidase (MPO). Isoprostanes were measured in urine. Baseline measurements were taken at the beginning of the study and after the ten-day washout period, with intervention measurements being taken at the end of weeks three and seven. All measurements were taken pre- and post-exercise.

Results of the study indicated that the athletes who consumed the drink of the invention during the study experienced decreased muscle damage and speedier recovery following exercise and more effective weight maintenance over time. The biological markers measured during the study also increased with exercise when the sport recovery drink was consumed. In addition to these scientific findings, the study also indicated that the athletes liked the text and texture of the drink of the invention.

This study shows that the invention is a heart-healthy soy-based sports drink that can help individuals recover more quickly following a workout—which, in turn, enhances their physical performance in subsequent workouts and ultimately plays a key role in their overall health and well-being. At the same time, the composition is appealing to individuals in terms of taste and texture, thus improving the likelihood that consumers will be willing to try the product and continue to use it once they have tried it.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

What is claimed is:

1. A soy protein composition comprising:
soy protein isolate, and sugar in a ratio of about 1:2 by weight.

2. The composition of claim 1 further comprising an emulsifier.

3. The composition of claim 2 further comprising vegetable oil.

4. The composition of claim 1 further comprising cocoa.

5. The composition of claim 1 wherein a portion of said soy protein isolate is replaced with milk protein

6. The soy composition of claim 1 wherein said protein is from about 1-10% by weight soy/milk protein isolate; from about 0.05-5.0% by weight vegetable oil; from about 0.05-1.0% by weight emulsifier; from and from about 80-99% by weight water.

7. The composition of claim 6 further comprising about 2.0-10% by weight of cocoa.

8. The composition of claim 1 that includes from about 3.0-5.0% by weight soy/milk protein isolate; from about 0.7-1.0% by weight vegetable oil; from about 0.2-0.4% by weight emulsifier; and from about 2.0-10% by weight of carbohydrate and from about 83.0-97.0% by weight water.

9. The composition of claim 8 further comprising from about 3.0-4.0% of cocoa.

10. The composition of claim 1 further including an ingredient selected from the group consisting of cocoa, sugar, vanilla extract, and combinations of the same.

11. The composition of claim 1 wherein the soy/milk protein isolate contains at least 85% by weight pure protein.

12. The composition of claim 1 that includes from about 2.0-10% by weight sugar; from about 2.0-5.0% by weight cocoa; and from about 0.02-0.5% by weight vanilla extract.

13. A method of reducing muscle glycogen breakdown comprising: administering to a person in need thereof an effective amount of the soy protein composition of claim 1.

14. The method of claim 13 wherein said muscle glycogen breakdown is that which is caused by strenuous exercise.

15. The method of claim 13 where in the muscle glycogen breakdown is that which is cause by illness.

16. The method of claim 13 wherein said composition is administered concurrent with said muscle glycogen breakdown event.

17. The method of claim 13 wherein said composition is administered after said muscle glycogen breakdown event.

18. The method of claim 13 wherein said composition is administered prior to said muscle glycogen breakdown event.

19. A method of manufacturing a soy/milk protein drink comprising:
blending water and emulsifier to form a slurry,
adding soy/milk protein isolate with stirring and agitation,
adding vegetable oil to form a mixture; and
pasteurizing the mixture.

20. A method of replenishing carbohydrate and protein that are lost due to exercise, illness, or other stress-related factors comprising:
ingesting a soy/milk protein drink, said soy/milk protein drink comprising water, soy/milk protein isolate, carbohydrate, cocoa, vegetable oil, and an emulsifier.

21. A soy protein drink comprising the following
Soy protein/milk protein isolate from about 1.0-10% by weight; sugar from about 2.0-10% by weight; vegetable oil from about 0.05-5.0% by weight; an emulsifier from about 0.05-1.0% by weight, water from about 80-99% by weight and cocoa from about 2.0-5.0% by weight.

22. The soy protein drink of claim 21 wherein said Soy protein/milk
protein isolate is about 3.0-5.0% by weight, said sugar is from 6.0-7.5% by weight, Vegetable oil from about 0.7-1.0% by weight, emulsifier, from about 0.2-0.4% by weight Water from about 83.0-97.0% by eight and cocoa from about 3.0-4.0% by weight.

23. A method of replenishing carbohydrate and protein that are lost due to exercise, illness, or other stress-related factors comprising:
ingesting a soy/milk protein drink, said soy/milk protein drink comprising: soy protein/milk protein isolate from about 1.0-10% by weight; sugar from about 2.0-10% by weight;
vegetable oil from about 0.05-5.0% by weight; an emulsifier from about 0.05-1.0% by weight, and cocoa from about 2.0-5.0% by weight, wherein said composition is mixed with an appropriate amount of water for ingestion.
